(19) United States
(12) Patent Application Publication
(10) Pub. No.: US 2010/0208082 A1
(43) Pub. Date: Aug. 19, 2010

(54) MEDIA SYSTEMS AND METHODS FOR PROVIDING SYNCHRONIZED MULTIPLE STREAMING CAMERA SIGNALS OF AN EVENT

(75) Inventors: John Buchner, American Fork, UT (US); James Jensen, American Fork, UT (US); Rod Miller, Alpine, UT (US)

Correspondence Address: Durham, Jones & Pinegar --;Intellectual Property Law Group, P.O. Box 4050, Salt Lake City, UT, 84110, US

(73) Assignee: BAND CRASHERS, LLC, Alpine, UT (US)

(21) Appl. No.: 12/642,641

(22) Filed: Dec. 18, 2009

Related U.S. Application Data
(60) Provisional application No. 61/203,483, filed on Dec. 18, 2008.

(51) Int. Cl. G06F 15/16; H04N 5/225; H04N 5/66; G06F 3/048

(52) U.S. Cl. 348/207.1; 348/739; 715/721; 709/231; 715/738; 348/E05.024; 348/E05.133

(57) ABSTRACT

A media system is provided having synchronized multiple camera signals of at least one event or activity for transmission over the internet to end users for selective display and/or manipulation. The media system may provide that end users are able to select and view and manipulate one or more of the multiple streaming video signals at will. The media system may be used in connection with a great variety of events or activities, including without limitation concerts, sports events, political events, sales events, movie premiers, public events, training events and religious events. A method is also provided having synchronized camera signals of at least one event or activity for transmission over the internet to end users for selective display and/or manipulation. The multiple camera signals are provided to end users for selective display and/or manipulation by end users. A media player is also provided for processing synchronized camera signals representing different views of at least one event or activity and providing end users of the media player the options of selectively displaying and/or manipulating at least one of the views at will.

### CROSS-REFERENCE TO RELATED APPLICATION

This application claims the benefit of U.S. Provisional Application No. 61/203,483, filed Dec. 18, 2008, the disclosure of which is hereby incorporated herein, in its entirety, by this reference.

### TECHNICAL FIELD

The present invention relates generally to providing streaming media (including video) signals from different perspectives or views of at least one event or activity to end users. More particularly, the present invention concerns simultaneously providing synchronized streaming media signals of different perspectives or views of at least one event or activity to end users, who may selectively display video of a desired perspective or view of the event or activity and/or manipulate one or more videos of the event or activity.

### RELATED ART

Software companies have developed systems and tools to enable providing various types of digital streaming content over the internet to computer users around the world, with respect to many types of entertainment and educational events. Competing systems in this area of technology include Adobe's Flash technology, Microsoft's SMOOTH STREAMING™ and SILVERLIGHT® platform, Move Networks' adaptive streaming technology, and many others. In many cases, such software and internet tools are designed for one specific and narrow focus: to provide streaming video, video communication, instant messaging, chatting, payment gateways, or another specific communication tool.

Digital applications of this type of technology are shown on nearly all websites that deal with music, education, entertainment, and social networking. Some examples are YouTube.com, MySpace.com, Facebook.com, My Video.com, MSN.com, iClip.com, MTV.com, ABC.com, NBC.com, and ESPN360.com. Generally, these applications for digital streaming of events are limited to a one screen view directed by a producer at the front end determining what content is sent to and viewed by end users.

Recently, some sports and music websites have began to enable users to see multiple views of the same or different events at the same time. However, these views are controlled by a content director or producer, and the end users are show only what the producers allow. U.S. Published Patent Application 2008/0189653 by Taylor et al. (hereinafter “Taylor”) discloses a system that provides multiple different views on different windows on a computer screen, in which each window presents a view of a performance or event that differs from the video of the performance or event shown in every other window. However, the system of Taylor does not provide for synchronization in real time of multiple perspectives or views of a single event or activity. In fact, because of the use of nested cell technology in the system disclosed by Taylor, even if multiple videos corresponding to different perspectives of the same event could be shown, it would be difficult for an end user to select different views of the event and to manipulate those views. Moreover, the system disclosed by Taylor does not provide for a multiple function player that can display and enable an end user to manipulate any or all of the synchronized views.

Another limitation in current entertainment technologies is the inability to integrate all related technologies and social networks into a single viewing experience for a user to easily utilize all related technologies to build public awareness of entertainment content and to monetize the content. For instance, a recording artist will have to develop a MYSPACE® webpage, a home page and several affiliated web pages just to maintain an internet presence. The artist will also need to develop a presence on various social networks, such as FACEBOOK®, TWITTER®, FLICKR®, and LINKEDIN® networks, to help them network and build fan bases. Finally the artist or his or her agent must maintain accounts with iTunes, CD-baby, and Amazon to sell digital products with his or her content thereon.

### SUMMARY

The present invention, in various embodiments, enables a developer of content for an event or activity to deliver and monetize that content directly to one or more end users, such as a fan base or another customer base. The developer may simultaneously provide multiple, synchronized video signals corresponding to different perspectives or views of the same event or activity to each end user. The video signals are accessible to an end user, who may simultaneously view a plurality of synchronized videos corresponding to different perspectives or views of the same event or activity. In some embodiments, each end user may be able to individually select a perspective of view for enlarged viewing and/or to individually manipulate one or more of the video images.

Teachings of the present invention are applicable to a great variety of events or activities, including, without limitation, concerts, sporting events, training programs, political events, sales events, movie premiers, public events, and religious events.

In one aspect, the present invention includes a media system for simultaneously delivering a plurality of video images of a single event or activity to at least one end user. An embodiment of a media system of the present invention includes a plurality of cameras, each providing a different perspective or view of the event or activity, or of a different part of the event or activity. Video signals corresponding to the video images captured by each camera may be transmitted to the internet (e.g., directly from the camera to an internet server; from the camera to production equipment to an internet server; etc.). One or more end users may then access and simultaneously view a plurality of the synchronized video signals from a media player, which may comprise an electronic device, such as a computer, a television receiver and television, a cellular telephone, or the like.

According to another aspect, the present invention includes a media player configured to provide an end user with a user interface (e.g., a computer program, etc.) that receives video signals of the same event or activity (e.g., from the internet, etc.) and simultaneously displays to an end user a plurality of synchronized video images corresponding to the event or activity. In some embodiments, the user interface of the media player may enable the end user to select a video corresponding to a particular perspective of the event or activity for enlarged viewing. Some embodiments of the user interface enable may enable the end user to manipulate (e.g., enlarge a selected region of an image, replay a portion of the video, slow the video down, speed the video up during replay, etc.) one or more of the video images.

The present invention also includes methods for providing a plurality of synchronized video images of a single event or activity to one or more end users. Such a method includes collecting images of the event or activity from a plurality of different perspectives or views. The collected images are then transmitted, as video signals (e.g., digital video signals, etc.) to the interne, where they may be simultaneously presented to one or more end users.

Other aspects and embodiments of various aspects of the present invention, as well as various features and advantages of various aspects and embodiments of the present invention, will become apparent to those of ordinary skill in the art through consideration of the ensuing description, the accompanying drawings, and the appended claims.

### BRIEF DESCRIPTION OF THE DRAWINGS

In the drawings:

FIG. 1 is a schematic representation of an embodiment of a media system that incorporates teachings of the present invention;

FIG. 2 is a flow diagram depicting an embodiment of a method of the present invention;

FIG. 3 shows an embodiment of a media player and an embodiment of a user interface of the media player that may be used in the embodiment of media system of FIG. 1 and in the embodiment of the method depicted by FIG. 2;

FIG. 4 shows another embodiment of a media player and user interface of the present invention;

FIG. 5 shows another embodiment of a user interface of a media player of the present invention;

FIG. 6 illustrates a different configuration of the embodiment of user interface shown in FIG. 5;

FIG. 7 depicts yet another configuration of the embodiment of user interface shown in FIGS. 5 and 6; and

FIG. 8 shows still another configuration of the embodiment of user interface shown in FIGS. 5-7.

Corresponding reference characters indicate corresponding parts throughout the several views. The exemplification set out herein illustrates one implementation of the disclosure, in one form, and such exemplification is not to be construed as limiting the scope of the disclosure in any manner.

### DETAILED DESCRIPTION

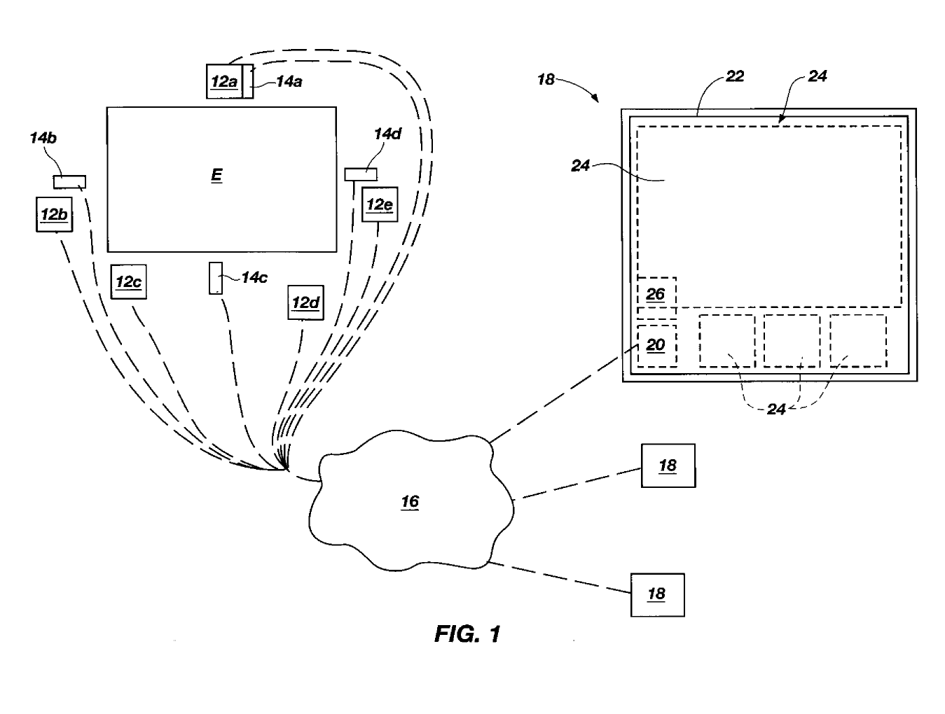

An embodiment of a media system 10 of the present invention is depicted by FIG. 1. A media system 10 that incorporates teachings of the present invention provides an end user with multiple synchronized views of at least one event or activity E, such as a concert, a sporting event, a training program, a political event, a sales event, a movie premiers, a public event, or a religious event. The end user may watch an event or activity E up close and from many different camera angles, or perspectives or views, from anywhere in the world on a suitable media player 18. In some embodiments, the event or activity E may be viewed by the end user in real time. In other embodiments, an end user may view a delayed transmission of an event or activity E or a previously recorded event or activity E.

In the depicted embodiment, media system 10 includes a plurality of cameras 12a, 12b, 12c, etc., (each of which may also be referred to herein more generally as a “camera 12”) positioned to capture or record video images of different perspectives of an event or activity E. In some embodiments, one or more of the cameras 12 may provide a high-definition (HD) image, which may further enhance the end user's viewing experience. In some embodiments, media system 10 may also include one or more microphones 14 (which may or may not be associated with one or more cameras 12a, 12b, 12c, etc.) for capturing or recording audio from the event or activity E.

The producer of an event or activity E may direct camera operators or cameras 12 to follow different specific participates in the event or activity E (e.g., the members of a band, the players in a sporting event, etc.) for the entirety of the event or activity E. For example, when a band is a playing a concert, there might be a drummer camera, a guitar camera, a bass camera, a keyboard camera, a backstage camera, an above stage camera, and cameras that surround the entire stage to provide end users U with a more lifelike, three-dimensional experience.

Video signals that correspond to the video images captured or recorded by cameras 12a, 12b, 12c, etc., and, optionally, one or more audio signals that correspond to audio captured or recorded by a microphone 14 may be transmitted to the internet 16. In some embodiments, a media system 10 may include a plurality of microphones 14, each of which provides audio of a separation portion of the event or activity E or from a separate location of the event or activity E. Such transmission may be effected directly by the cameras 12a, 12b, 12c, etc., and microphones 14 or indirectly, through production equipment (not shown). In any event, a plurality of synchronized video signals from the same event or activity E is simultaneously transmitted to the internet 16.

An end user may access video images from the internet 16 by use of a media player 18, such as a computer, a television receiver (e.g., a satellite receiver, a cable receiver, etc.) and television, a cellular telephone, or any other suitable electronic device. A media system 10 of the present invention may, in some embodiments, employ adaptive steaming technologies that select bit rates of the streaming video that match to the capabilities of the end user's media player 18 to eliminate irritating pauses that might otherwise occur as digitally streamed media is buffered.

Media player 18 may include a processing element 20, which retrieves the plurality of synchronized video signals (e.g., streaming media, digital video (and audio) files, etc.) from the internet 16, as well as a display 22 that communicates with the processing element 20 to simultaneously display a user interface 24 that includes a plurality of sections 26 for separately and simultaneously displaying the plurality of video images (and output corresponding audio). In some embodiments, media player 18 may include memory 28 to enable the end user to record the video signals, as well as the end user's personalized production generated from the multiple video images of the event or activity E.

The user interface 24 of the media player 18 may provide the end user with a multi-function “player” on his or her media player 18 to enable the end user to chose from the multiple synchronized video images, to scroll into a particular time location of a selected video image at any time up to the current time of at least one event or activity, to watch a video image in slow motion or stop motion, to remove various elements from a video image, including different sound tracks, and to provide the end user with control over many other functions, some of which are discussed below. A media system 10 of the present invention places the end user close to the action (e.g., in the front row, etc.) and, in some embodiments, in the middle of the action (e.g., on stage, on the playing field, etc.), provided that a camera 12 is available to capture video images from the desired vantage point. The end user is able to select a desired video image from a number of video images that provide different perspectives or views, or camera angles or vantage points, of the event or activity. An end user may be able to choose a particular camera angle (video image) to view in real time, to have three-dimensional ability to move around the event or activity E or even around each individual participant in the event or activity E, to stop motion, to slow motion, to have instant replay, to loop a sequence of a particular event, to fast forward, to play back, and many other video production functions. An end user may also become part of at least one event by being able to turn on and off individual audio tracks, such as, in the example of a concert, the drums, guitars, keys, or whatever instrumentation may be present.

In some embodiments, video images may be viewed for as long as desired and modified to a particular end user's individual preferences.

A user interface 24 may provide one or more sections, or windows, for displaying social network content to enable the end user to communicate with other fans or fan groups, to be part of a fan video event, to discuss the event with friends as if they were there, to view various content from web pages, TWITTER® feeds, FACEBOOK® messages, blogs and other types of electronic messages to review a variety of different related content, such as information, reviews and discussions of the artists, their history, their schedule, their fans and critiques of other related events. A user may also bring onto the screen monetizing and merchandising information and websites, and information and websites regarding purchasing tickets for other related events. In addition, administrative functions may be inserted on the end user's screen, as needed.

All of the foregoing functions may be controlled by an on-screen player, adapted to provide the usual convention functions, and also to enable end users to select various camera views at will and to modify the size and presentation of each such view, as well as to bring onto the screen the various monetizing windows and social windows discussed above.

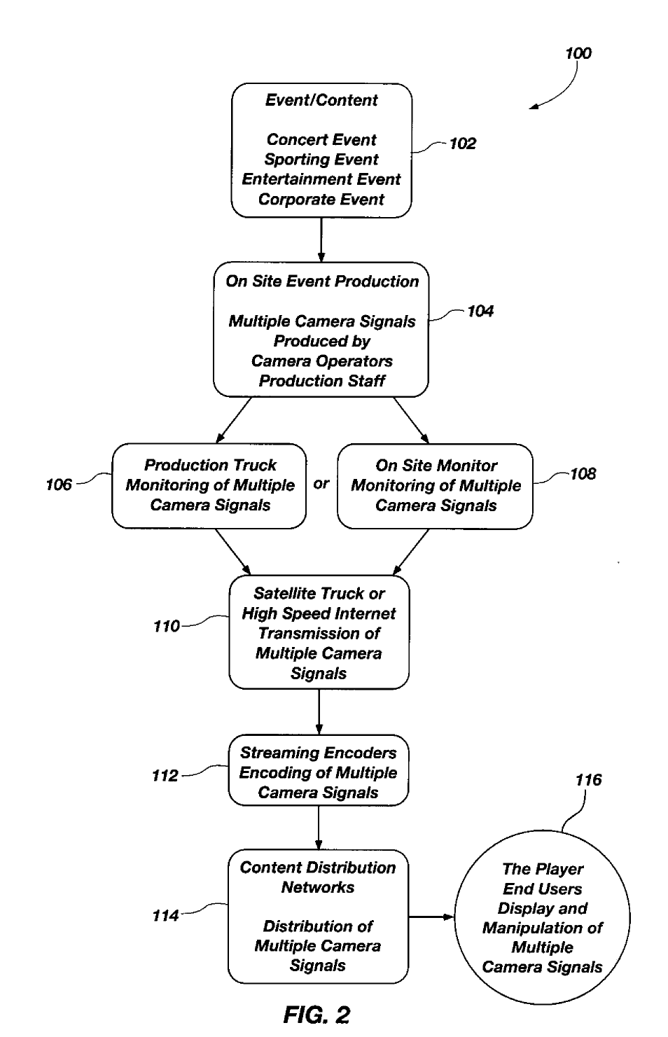

Referring now to FIG. 2, a flow diagram 100 is shown of one embodiment in which multiple synchronized views of at least one event or activity are processed and presented to a viewer. The flow chart 100 reflects the process involved from the start of at least one event or activity, such as a concert or game, to an end user logging on and viewing the event or activity.

At reference 102, an event or activity is conducted. The event or activity may be a concert, athletic event, training program, seminar, conference or any other event of interest to others. In the prior art, a recording of the event was produced by a crew of cameras and camera operators who would video the event with as many cameras as it takes to accomplish obtaining good coverage of the event. A producer would instruct camera operators about the shots that the producer wanted to be captured. The producer would then determine which of those camera angles would be broadcast out to the viewers watching the event, with only one camera angle broadcast at a time. Thus, the end user would experience whatever the producer decided to show him or her.

In the present embodiment, at reference 104, five cameras are used to provide different angles from various positions. One or more (e.g., all) video images may be recorded in HD and transmitted as an HD video signal. A producer instructs camera operators on the images to be captured from different locations and angles. In some embodiments, however, the producer may not select or produce a single camera signal for transmission. Rather, all of the video images that are obtained during the event or activity may be broadcast and, thus, made simultaneously available to each end user for him or her to orchestrate according to their personal wishes.

In some embodiments, the multiple video images may be monitored in a production truck, at reference 106, or on site, at reference 108. Then, at reference 110, the multiple video images or their corresponding video signals are delivered to a unit to link to the internet, either via satellite or other high-speed internet input device. At reference 112, the video images may be encoded as streaming video signals for transmission to the internet. Then, at reference 114, the streaming video signals may be delivered to servers for a variety of network services, such as the network services provided by AT&T, Comcast, DirecTV, DISH Networks, Limelight, Level 3 or Acami.

The streaming video signals may be provided, at reference 116, to a video player acting as an end user interface.

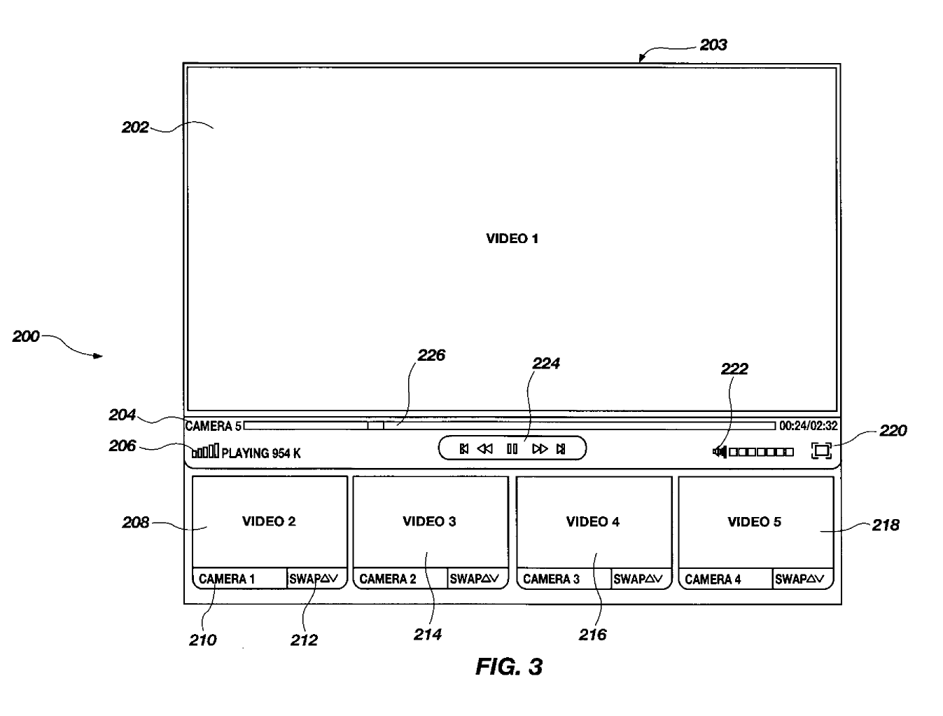

Referring now to FIG. 3, a media player 200 with a user interface 201 according to a present embodiment is shown. The video player 200 can enable an end user to become a producer and view the experience he or she wants to have. With the present embodiment, an end user is able to choose which of the supplied production views he or she wants to view at any time. Whether the event or activity is broadcast live or on demand, end users can choose from multiple angles and locations. Even a 360° three-dimensional experience can be provided, if the necessary video signals are broadcast. An end user is able to choose from any given number of angles at any single event or activity, an in some embodiments can move in, around, and through an event in real time from any location.

An HD screen or monitor 202 is provided. A camera view 203 showing as an expanded image on the screen or monitor 202 of media player 200 is displayed, and the number of the camera is shown at 204. A bandwidth display 206 is provides to show the bit rate of the streaming video that can be delivered to the screen or monitor 202 of media player 200. A second camera angle thumbnail view 208 is shown, which may, in some embodiments, have a 125 pixel by 70 pixel display. The number of the camera associated with thumbnail view 208 is shown at 210. A button 212 is provided to enable the view at 208 to be swapped with the current view 203 on the screen or monitor 202.

A third camera angle thumbnail view 214 is shown, and fourth and fifth camera angle thumbnail views 216 and 218 are displayed, respectively. These thumbnail views may also be displayed with a 125 pixel by 70 pixel configuration. A user input button 220 is provided for expanding the image on screen or monitor 202 to a full screen display. Another user input button 224 is provided for volume control. Control buttons 224 enable a user to manipulate the current views using full DVR functionality including play, stop, pause, fast forward, rewind and skip. A play head timeline 226 is shown for showing the progress of the current video stream.

In one configuration of the foregoing embodiment, a plurality of HD streaming video signals is provided to a video player developed on the SILVERLIGHT® platform. On initialization, a user interface player .xap file reads an associated mediafeed.xml file that contains variables for adaptive streaming “urls” to a live origin server on a content distribution network. These “urls” can be either from Move Networks QVT “urls” or SMOOT STREAMING™ “midBitrates.” The media player 200 detects the computer configuration of the user, as well as other features, such as ram, screen size, processor functionality and current bandwidth. This detection enables the video player to display the highest bit rate possible for the available bandwidth and to process the encoded bit rate.

It is important to note that this system transmits multiple camera signals from a single event or activity, where all camera feeds are live at all times, except for when and end user implements a special function, such as stop motion or instant replay. The video player takes encoded QTVs or midBitrates and enables an end user to choose from those streams. In some of the current embodiments, five cameras are currently used, based on the streaming capabilities and bandwidth currently available. It should be understood that future developments in these capabilities will enable the use of additional cameras and additional functions.

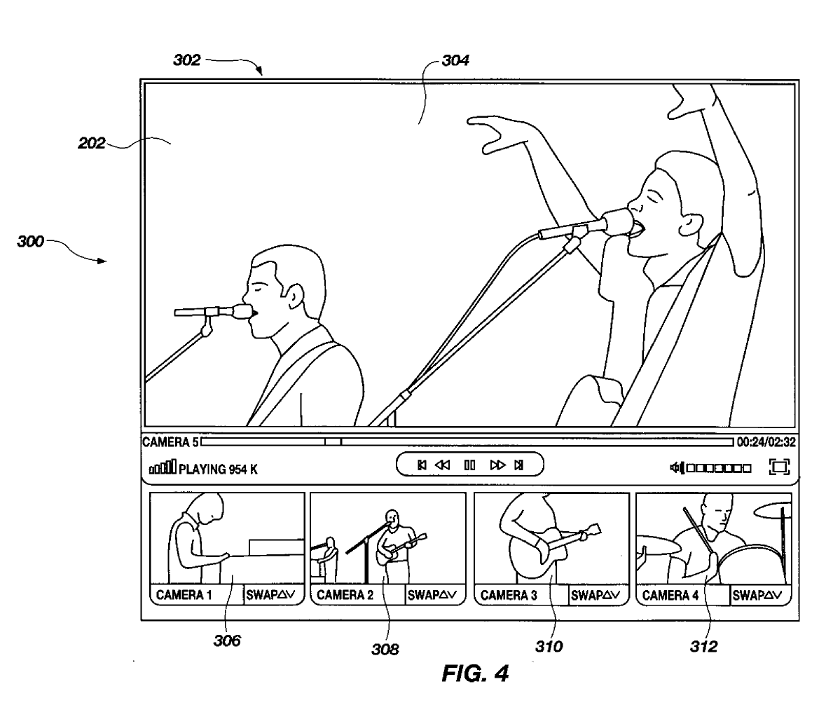

FIG. 4 shows another embodiment of a user interface 301 that may be displayed on a screen or monitor (not shown) of a media player 300. As discussed above, the controls enable an end user to select from five different views. One of these views 302 is shown on the full screen 304 of the media player 300. In addition, thumbnail view 306 displays the keyboard player, thumbnail view 308 shows one guitar player, and thumbnail view 310 shows another guitar player, and thumbnail view 312 displays a shot of the drummer.

In addition, many other views may be shown, such as a view providing the reaction of the audience on a particular song. In addition, small cameras can be placed into sports shirts, helmets, and other places for a first person experience. For example, a fiber optic camera may be sewn into the shirt of a professional basketball player or the helmet of a football player, so that end users would be able to log in and watch the game from the sports player's perspective.

Accordingly, the present embodiment provides a unique video player having the ability of selecting from any of the streaming signals to show the views desired by an end user. Further, many features may be and have been included in a video player of the present embodiments that television sets or computer systems currently provide, such as rewind, forward, instant replay, back to live, large screen, full screen, event scrolling, and volume control.

In addition, a media player that incorporates teachings of the present invention may provide for adaptive streaming and monitoring of bandwidth. As previously discussed, these capabilities make such a media player compatible with any of the current streaming technologies, whether adaptive or not. These networks include technology developed by Move Networks that enables an end user computer to analyze and adjust the streaming quality to the available bandwidth in two second increments, eliminating buffering. Microsoft has also produced a technology called SMOOTH STREAMING™ using Microsoft's SILVERLIGHT® platform.

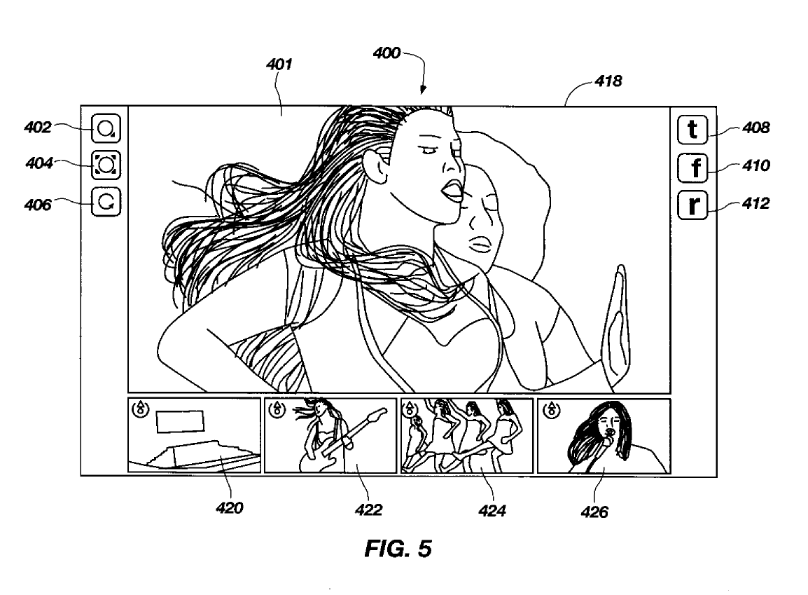

FIG. 5 illustrates an embodiment of a media player 400 of the present invention, in which a view 418 from one of the cameras has been expanded to cover most of the area of the user interface 401 displayed by the screen or monitor (not shown) of the media player 400, except for the thumbnail views at the bottom of the screen and a few controls on the left and right sides of the user interface 401. The function controls shown in FIGS. 3 and 4 are configured to disappear from the screen or monitor of the media player 400 when a cursor is not present, providing for a less cluttered view of the user interface 401 displayed by the screen or monitor of the media player 400.

Additional functional controls are shown on the left side of the user interface 401. Control 402 enables a more expanded view on the monitor in which the other controls and thumbnail views disappear. Control 404 enables a view on the screen of the video player to expand to cover the entire screen of a monitor. Control 406 provides for instant replay of the last few seconds previously viewed.

In addition, in FIG. 5, social networking controls on shown on the right side of the user interface 401. Control 408, labeled “t,” is a control that provides access to the TWITTER® social network. Control 410, labeled “f,” is a control that provides access to the FACEBOOK® social network. Control 412, labeled “r,” is a control that provides access to the FLICKR® social network.

View 418 is shown on the user interface 401 of the screen or monitor (not shown) of the media player 400. Additional views of the concert event are shown at 420-426 along the bottom of the user interface 401. As before, any of these thumbnail views can become the large view shown on the user interface 401 by clicking on that thumbnail view. When that is done, the current large view on the user interface 401 becomes one of the thumbnail views.

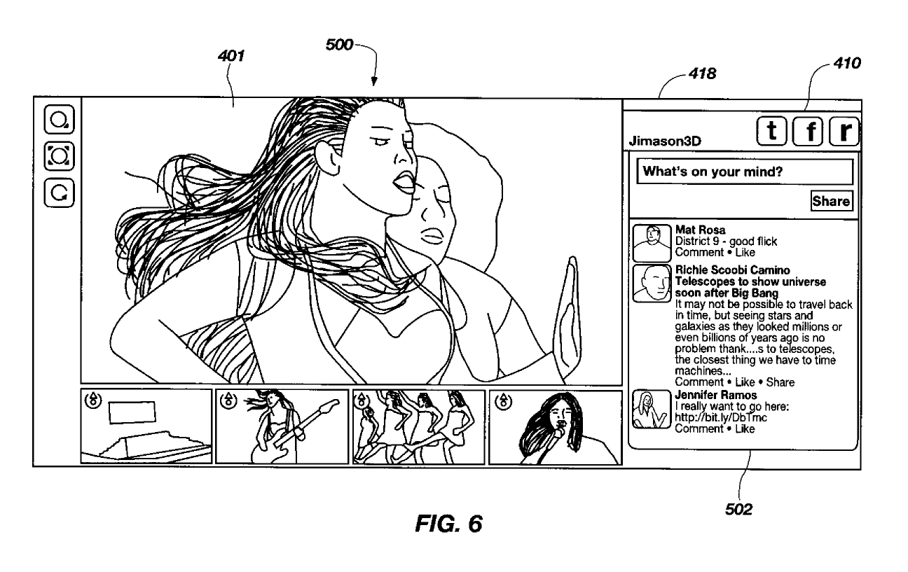

Referring now to FIG. 6, another embodiment of media player 500 with a different configuration of user interface 401 is shown in which the social control button 410 labeled “f” has been activated. This action results in an inset screen 502 superimposed on a portion of user interface 401 in which a webpage from the social network FACEBOOK® has been provided. Similar action to activate the other social network controls will provide at least one inset screens for the TWITTER® and FLICKR® social networks.

Thus, while viewing an event or activity, a user can log on to a social network and view the network in an insert screen 502. A user can thereby view a blog, post comments, invite friends to join the viewing experience, chat about the event or about other events with friends or with the general viewing population. In addition, this insert screen 502 can be used to monetize the event, by charging a fee to end users to access the event or activity and the resulting content. Further, the insert screen 502 may also enable a user to become involved in various merchandising and financial functions, such as purchasing a ticket for another event or buying merchandise of the performing group.

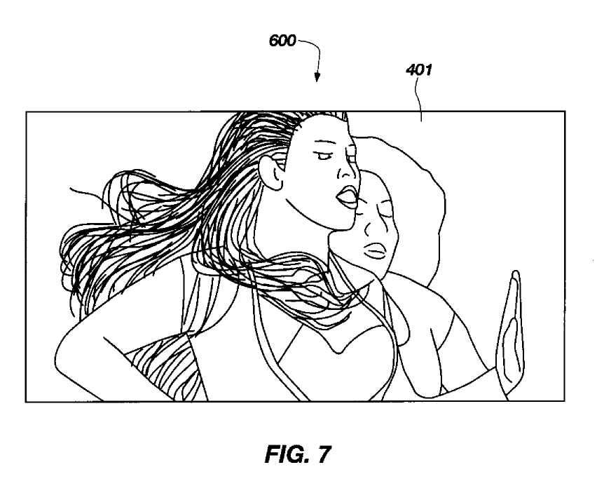

FIG. 7 shows another configuration 600 of the user interface 401 which has been further expanded to eliminate the thumbnail views 420-426 shown in FIGS. 5 and 6. Those views appear on screen 401 when a cursor is positioned at the bottom of the screen 401.

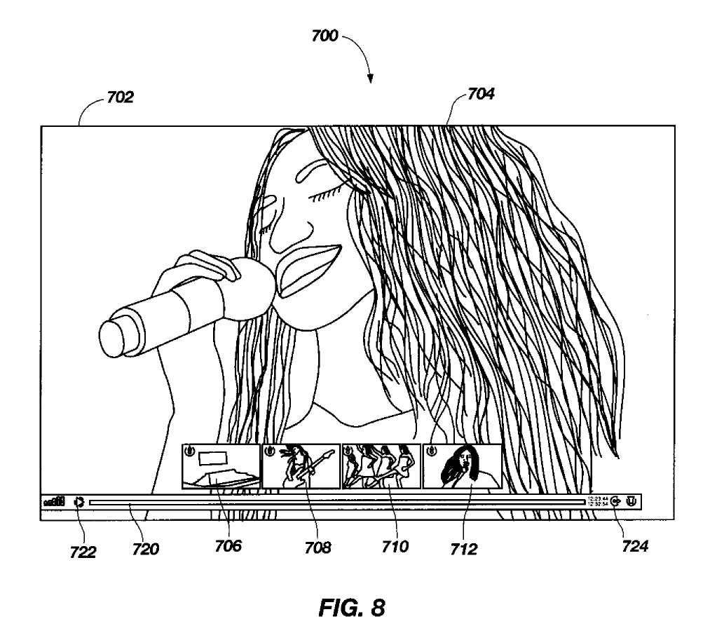

FIG. 8 shows a full-screen configuration 700 of an entire screen or monitor 702 that results from activation of the full-screen control 404 shown in FIG. 5. The view 704 that was displayed on a user interface is thereby expanded to cover the screen or monitor 702. Four thumbnail views 706-712 are displayed at the bottom of the screen or monitor 702, which have also been configured to time out and disappear or be hidden from the screen in the absence of the cursor. A player time line 720 with a play button 722 and a fast forward button 724 are shown at the bottom of the screen or monitor 702. They may also be hidden in the absence of a cursor for a certain time.

Accordingly, the foregoing embodiments provide a multiple camera view player that has many integrated functions, including without limitation the following: (1) switching between camera views, (2) volume control, (3) bandwidth indicator, (4) stretch screen, (5) full screen, (6) instant replay, (5) full screen with other camera angles, (6) synchronized camera angle play, and (7) integrated access to social networking sites, such as the TWITTER®, FACEBOOK®, and FLICKER® social networking sites.

In addition, some embodiments of user interfaces of a media player of the present invention may include an advertising-based revenue-generating website. Events may be syndicated to affiliate websites with various controls as to the advertising and marketing materials shown on each affiliate website. In this mode, the events may be shown free to the end users, with revenue being realized from the advertising. In another embodiment, there may be no advertising and the events are provided on a pay-per-view basis.

It should be understood that any of the video player embodiments shown in FIGS. 3-8 can be assembled by a web developer having skill in the art, upon being provided with instructions for the functions desired by the system developer.

The genius of the present invention lies in (1) the processes involved in transmitting all views from all video feeds filming an event or activity to end users and (2) providing a unique video player for display on a computer monitor, television screen, or other media player that enables a user to view and manipulate all of the transmitted views, as desired. By doing so, an end user becomes his or her own producer and director of at least one event or activity, dependent only on the number and position of the cameras videotaping the event or activity.

While the foregoing disclosure has been described as having a certain features and provisions, the present disclosure can be further modified within the spirit and scope of this disclosure. This application is therefore intended to cover any variations, uses, or adaptations of the disclosure using its general principles. For example, although five different camera views are discussed in some of the foregoing embodiments, any multiple of cameras may by utilized to still be included in the present invention. Moreover, other functions besides social networking, monetizing, and administration may be employed in conjunction with multiple views of at least one events or activities. In addition, although the foregoing embodiments discuss only one event or activity, it is possible to include multiple events or activities within the scope of the present invention.

Further, this application is intended to cover such departures from the present disclosure as come within known or customary practice in the art to which this disclosure pertains and which fall within the limits of the appended claims.

What is claimed:

1. A media system for providing synchronized multiple camera signals of at least one event or activity, comprising:
a plurality of cameras for simultaneously obtaining video images of at least one event or activity from a plurality of different perspectives and for transmitting video signals corresponding to each of the video images;
an internet server configured to receive each of the video signals and for simultaneously making each of the video signals available to at least one end user; and
an end user device connectable to the internet server and including a user interface configured to simultaneously receive the video signals and to simultaneously display each of the video images that correspond to the video signals to the at least one end user.

2. The media system of claim 1, wherein the user interface of the end user device enables the at least one end user to select a video image from a plurality of thumbnail video images for enlarged viewing.

3. The media system of claim 1, wherein the user interface of the end user device enables the at least one end user to manipulate at least one of the video images.

4. The media system of claim 1, wherein the end user device comprises at least one of a computer, a television receiver and television, and a cellular telephone.

5. The media system of claim 1, wherein the signals comprise streamed video signals.

6. The media system of claim 1, further comprising:
at least one microphone for obtaining audio of the at least one event or activity and for transmitting an audio signal corresponding to the audio.

7. The media system of claim 6, wherein the internet server is further configured to receive the audio signal and the end user device is configured to receive the audio signal simultaneously with the video signals.

8. The media system of claim 6, wherein the audio signal is combined with at least one video signal.

9. The media system of claim 6, comprising a plurality of microphones.

10. The media system of claim 9, wherein at least two microphones of the plurality of microphones correspond to different cameras of the plurality of cameras.

11. The media system of claim 1, wherein the user interface displays other information simultaneously with the video images.

12. The media system of claim 1, wherein the user interface enables the end user to transmit information while displaying the video images.

13. An media player for enabling an end user to view multiple video images of an event or activity, the media player comprising:
a processing element;
a display element in communication with the processing element;
a user interface generated by the processing element for display by the display element, the user interface comprising a plurality of sections, each section configured to display a video image of one perspective of an event or activity, the plurality of sections configured to display video images of different perspectives of the same event or activity.

14. The media player of claim 13, wherein the plurality of sections of the user interface includes:
a large section for displaying an enlarged image of a video of a selected perspective of the perspectives provided by the video images; and
a plurality of thumbnail sections for displaying remaining video images.

15. The media player of claim 14, wherein the user interface further includes:
at least one section for displaying messages received by or sent from the media player.

16. The media player of claim 14, wherein the user interface further includes:
at least one section corresponding to a monetizing or merchandising website associated with the event or activity.

17. The media player of claim 14, wherein the user interface further includes:
at least one section for displaying an administrative website.

18. A method for transmitting a plurality of images of an event or activity, comprising:
obtaining video images of an event or activity from a plurality of perspectives; and
simultaneously streaming the video images over the internet to a website;
simultaneously presenting each of the video images on the website.

19. The method of claim 18, further comprising:
providing an end user with access to the website.

20. The method of claim 19, further comprising:
enabling the end user to selectively enlarge at least one of the video images.
